(19) United States
(12) Patent Application Publication
(10) Pub. No.: US 2013/0271825 A1
(43) Pub. Date: Oct. 17, 2013

(54) CONDENSING TYPE OPTICAL SHEET

(71) Applicants: Kyung Jong Kim, Yongin-si (KR); Chang Won Park, Yongin-si (KR); Eui Young Shin, Seongnam-si (KR); Chang Pyo Hong, Yongin-si (KR); Hong Gu Hwang, Incheon (KR)

(72) Inventors: Kyung Jong Kim, Yongin-si (KR); Chang Won Park, Yongin-si (KR); Eui Young Shin, Seongnam-si (KR); Chang Pyo Hong, Yongin-si (KR); Hong Gu Hwang, Incheon (KR)

(73) Assignee: KOLON INDUSTRIES, INC., Gyeonggi-do (KR)

(21) Appl. No.: 13/976,856

(22) PCT Filed: Dec. 29, 2011
(86) PCT No.: PCT/KR2011/010302

§ 371 Date: Jun. 27, 2013

(30) Foreign Application Priority Data
Dec. 31, 2010 (KR) 10-2010-0140821

(51) Int. Cl. G02B 27/10

(52) U.S. Cl. CPC G02B 27/1066
USPC 359/350; 359/625

(57) ABSTRACT

This invention provides an optical sheet for use in for example a liquid crystal display, which prevents scratching and wet-out due to contact between films and minimizes the drop in performance of the optical sheet due to adhesive stains when an additional protective film is adhered and then peeled off.

### TECHNICAL FIELD

The present invention relates to an optical sheet for use in, for example, a liquid crystal display (LCD).

### BACKGROUND ART

A condensing type optical sheet is an example of an optical sheet used to increase the luminance of light emitted from an optical display in a normal direction to the surface of the optical display or in an axial direction of the surface of the optical display. Such a sheet is imparted with a structured surface having an array of linear prism elements.

Particularly, in order to further increase the amount of light directed in an axial direction, two condensing type optical sheets having prism elements intersecting at about 90° are closely disposed, which is known in the art. However, an optical display using such a structure may have visually apparent bright dots, stripes, and lines. This wet-out state results from optical coupling between surfaces of films which are in contact with each other or which are adjacent to each other. To solve this problem, high prism elements and low prism elements may be arranged together so as to limit the contact between the films.

On the other hand, the prism elements have a triangular cross-section with peaks, which is a structure known to be very efficient at increasing the amount of light emitted from a backlight unit (BLU) in the axial direction. However, such peaks are comparatively easy to damage undesirably causing scratching on the film. In order to prevent the generation of defects such as scratching and white spots due to external impurities and so on in the course of transporting the assembled BLU to a LCD module assembly enterprise, a protective film, called a dummy sheet, may be applied. Although the dummy sheet prevents the introduction of external impurities and thus protects the condensing type optical sheet, it must be removed upon manufacturing the LCD module. However, after the dummy sheet is removed from the condensing type optical sheet, adhesive stains may be left behind, undesirably deteriorating the outer appearance of the optical sheet.

### DISCLOSURE OF INVENTION

### Technical Problem

Accordingly, the present invention has been made keeping in mind the above problems occurring in the related art, and the present invention is intended to provide an optical sheet, which may prevent scratching and wet-out due to the films making contact, and may minimize the drop in performance of the optical sheet due to adhesive stains when an additional dummy sheet is adhered and then peeled off.

### Solution to Problem

According to an embodiment of the present invention, an optical sheet is provided, comprising a structured layer having an array of a plurality of three-dimensional structures in a prism shape having a triangular cross-section, wherein the structured layer has uniform pattern groups each including 5˜20 three-dimensional structures having the same height, and a non-uniform pattern disposed between the uniform pattern groups and having a three-dimensional structure whose height is greater than the height of the three-dimensional structures of the uniform pattern groups and whose ridge is provided in the shape of a wave having a vertical amplitude.

To minimize the contact area with ridges of prisms in order to prevent the generation of stains due to the dummy sheet and the generation of wet-out, the height of the three-dimensional structure of the non-uniform pattern may be at least 10% greater than the height of the three-dimensional structures of the uniform pattern groups.

In this embodiment, the height of the three-dimensional structure of the non-uniform pattern may be 15˜25% greater than the height of the three-dimensional structures of the uniform pattern groups.

Also to minimize the contact area with ridges of prisms in order to prevent the generation of stains due to the dummy sheet and the generation of wet-out, the pitch of the three-dimensional structure of the non-uniform pattern may be at least 10% greater than the pitch of the three-dimensional structures of the uniform pattern groups.

In this embodiment, the pitch of the three-dimensional structure of the non-uniform pattern may be 15˜25% greater than the pitch of the three-dimensional structures of the uniform pattern groups.

In this embodiment, the structured layer may be formed of any one selected from among polymer resins including UV or thermal curable resins.

### BRIEF DESCRIPTION OF DRAWINGS

FIG. 1 is a perspective view showing an optical sheet according to an embodiment of the present invention;

FIG. 2 is a cross-sectional view of FIG. 1;

FIG. 3 is a perspective view showing another optical sheet used to compare structural features with the optical sheet according to the embodiment of the present invention; and

FIG. 4 is a view showing a measuring device for evaluating scratch resistance of the optical sheet according to the embodiment of the present invention.

### BEST MODE FOR CARRYING OUT THE INVENTION

Hereinafter, a detailed description will be given of the present invention with reference to the appended drawings.

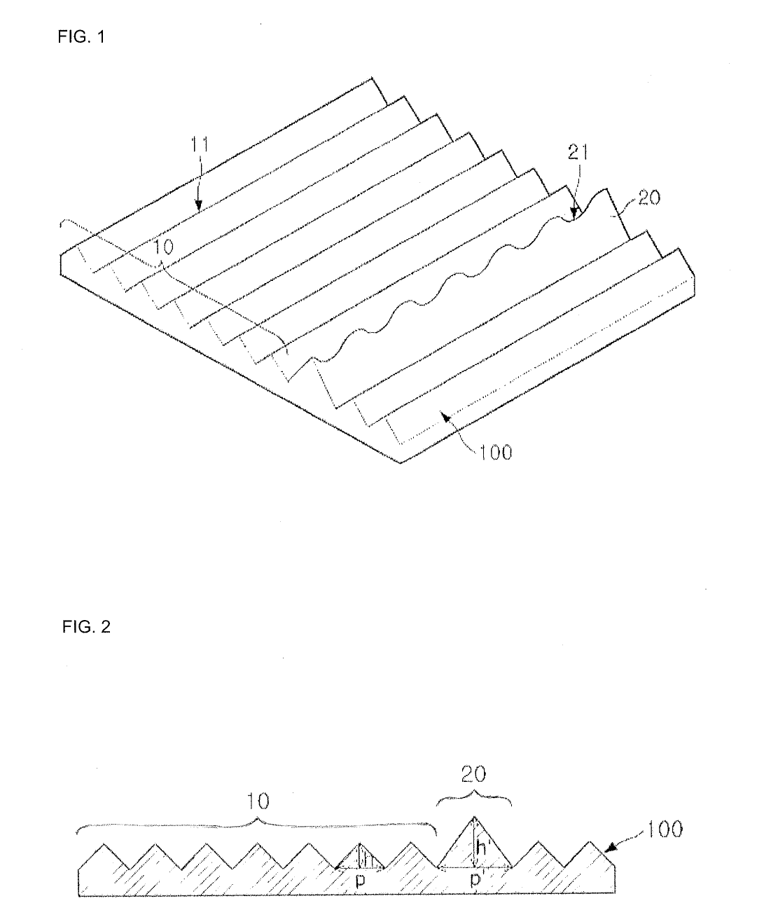

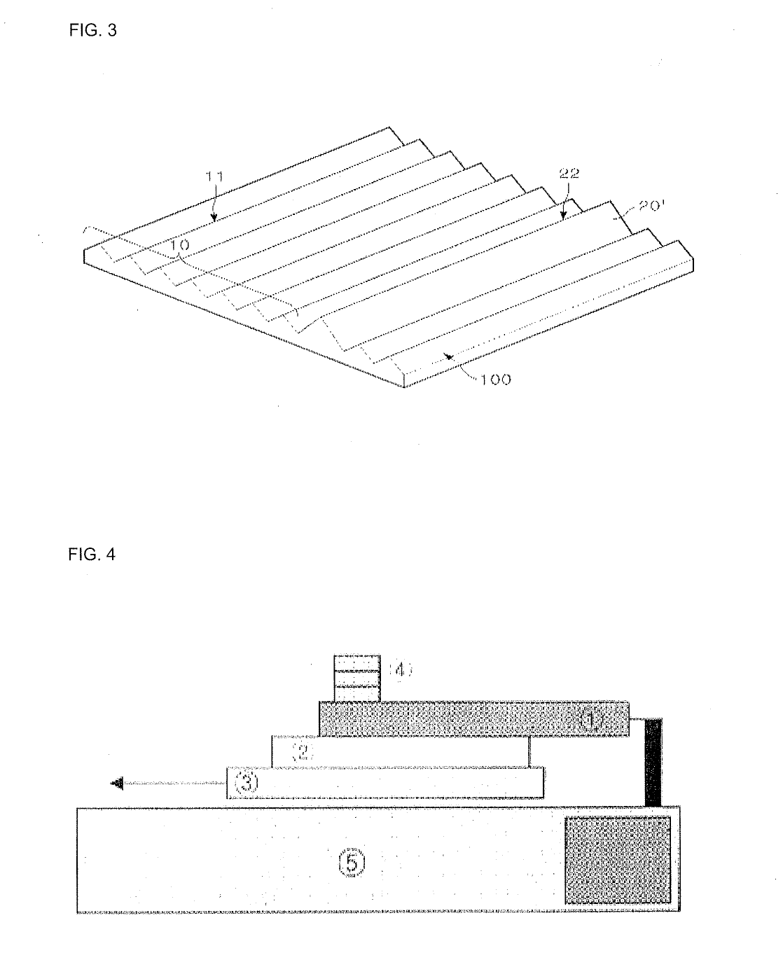

FIG. 1 is a perspective view showing an optical sheet according to an embodiment of the present invention, FIG. 2 is a cross-sectional view of FIG. 1, and FIG. 3 is a perspective view showing another optical sheet used to compare the effects caused by the structural features of the optical sheet according to the embodiment of the present invention.

The optical sheet according to the present invention includes a structured layer 100.

The structured layer 100 has a plurality of three-dimensional structures, and these structures are provided in the form of a prism having a triangular cross-section.

According to an embodiment of the present invention, the optical sheet includes a structured layer 100 having uniform pattern groups each including 5˜20 three-dimensional structures having the same height and a non-uniform pattern disposed between the uniform pattern groups and having a three-dimensional structure which is higher than the three-dimensional structures of the uniform pattern groups and wherein the ridge thereof is provided in the shape of a wave having a vertical amplitude.

As shown in FIGS. 1 and 2, the case where the number of three-dimensional structures of each of the uniform pattern groups 10 is 7 is illustrated, but the present invention is not limited thereto. Taking into consideration the adhesion area with the dummy sheet, the number of three-dimensional structures of each of the uniform pattern groups 10 may be 5˜20.

In the structured layer of the optical sheet according to the embodiment of the present invention, the uniform pattern groups 10 are provided in a prism shape having a triangular cross-section, each group including 5˜20 three-dimensional structures having the same height (h) which are continuously disposed. As such, it will be understood that the ridge 11 of the prism shape is linear.

When two optical sheets having only the uniform pattern groups that are continuously formed are brought into contact with each other, wet-out may occur, and also, because the three-dimensional structures have the same height (h), the contact area may increase, undesirably facilitating the generation of scratching.

Hence, the structure layer 100 of the optical sheet according to the embodiment of the present invention includes the non-uniform pattern 20 disposed between the uniform pattern groups 10.

The non-uniform pattern 20 includes a three-dimensional structure whose height (h′) is greater than the height (h) of respective three-dimensional structures of the uniform pattern groups 10. When the non-uniform pattern 20 having the height difference is provided in this way, wet-out between two films may be prevented and scratch resistance may be enhanced.

Furthermore, such a non-uniform pattern 20 is configured such that the ridge 21 thereof is provided in a wave shape having a vertical amplitude, unlike the ridges 11 of the three-dimensional structures of the uniform pattern groups 10.

As shown in FIG. 3, in the case where a non-uniform pattern 20′ which is not different from the three-dimensional structures of the uniform pattern groups 10 except for in terms of the height is disposed between the uniform pattern groups 10, wet-out between two films may be prevented and scratch resistance may be improved; however, limitations are imposed on preventing the adhesive stains caused by the dummy sheet. Specifically, in the case where the dummy sheet having an adhesive layer is superimposed on the non-uniform pattern 20′ having only the height difference, the adhesive layer may come into complete contact with the protruding linear ridge 22 of the non-uniform pattern. In this case, adhesive stains may be left behind on the optical sheet even after the dummy sheet has been removed during the manufacture of the optical device.

In contrast, as shown in FIGS. 1 and 2, in the case where the non-uniform pattern 20 having the height difference and the wave-shaped ridge is provided, the surface of the adhesive layer of the dummy sheet that comes into contact with the optical sheet may be minimized, and also the contact area between the two optical sheets may be minimized, thus preventing wet-out, improving scratch resistance and minimizing the drop in performance of the optical sheet attributed to the adhesive stains.

In the optical sheet according to the embodiment of the present invention, the height (h′) of the non-uniform pattern 20 is greater than the height (h) of respective three-dimensional structures of the uniform pattern groups 10. In order to minimize the contact area between the adhesive layer of the dummy sheet and the optical sheet, h′ may be at least 10% and preferably 15˜25% greater than h.

In the optical sheet according to the embodiment of the present invention, the pitch (p′) of the non-uniform pattern 20 may be greater than the pitch (p) of respective three-dimensional structures of the uniform pattern groups 10. This is considered to be because the pitch of the three-dimensional structures having the same vertical angle may naturally increase in proportion to an increase in the height thereof, when considering the ease of carrying out the patterning process. Hence, the pitch (p′) of the non-uniform pattern 20 may be at least 10% and preferably 15˜25% greater than the pitch (p) of respective three-dimensional structures of the uniform pattern groups 10.

In the optical sheet according to the embodiment of the present invention, the ridge 20′ of the non-uniform pattern 20 may be in a wave shape having a vertical amplitude wherein the cycle or height of the amplitude may be appropriately adjusted so as to minimize the contact area between the adhesive layer of the dummy sheet and the optical sheet.

Accordingly, the amplitude of the wave shape may be at least 5 μm, and the vibration cycle may be at least 50 μm.

As the resin for the structured layer 20, any curable resin may be used without particular limitation so long as it permits light to pass therethrough. Any polymer resin including a UV or thermal curable resin may be used without limitation, and also the type of a polymer resin may be determined in consideration of the refractive index with a substrate layer which will be described below.

Such a structured layer 100 may be formed on an additional substrate layer, and the substrate layer may be made of a polyethyleneterephthalate resin, a polymethyl-methacrylate resin, a polycarbonate resin, a polypropylene resin, a polyethylene resin, a polystyrene resin, or a styrene-acrylic copolymer resin.

The thickness of the substrate layer may be 10˜1000 μm and preferably 15˜400 μm so that the desired mechanical strength, thermal stability and flexibility can be achieved and the loss of transmitted light can be prevented.

In the structured layer 100, the height (h) and pitch (p) of respective three-dimensional structures of the uniform pattern groups 10 are not particularly limited, but may be 10˜30 μm and 25˜60 μm, respectively.

The condensing type optical sheet according to the present invention may be manufactured using conventionally known techniques. Specifically, a coating solution comprising a UV or thermal curable resin may be applied on one surface of the substrate layer 10 and then cured, thus forming the structured layer 20.

### MODE FOR THE INVENTION

The following examples are set forth to illustrate the present invention and are not to be construed as limiting it.

### Example 1

As a substrate layer, a 125 μm thick polyethyleneterephthalate film H32P (available from KOLON) (refractive index: 1.49) was used.

A structured layer was formed by manufacturing a mold having uniform pattern groups 10 each including seven prisms having a pitch (p) of 50 μm and a height (h) of 25 μm and a non-uniform pattern 20 having a pitch (p′) of 60 μm, a height of (h′) of 30 μm and a wave-shaped ridge having an amplitude of 5 μm and a vibration cycle of 100 μm, injecting an acrylic UV curable resin composition into the mold, and curing it with UV light. Thereby an optical sheet like that shown in FIGS. 1 and 2 was manufactured.

### Example 2

An optical sheet was manufactured in the same manner as in Example 1, with the exception that the non-uniform pattern 20 of the structured layer had a pitch (p′) of 56 μm and a height (h′) of 27 μm.

### Example 3

An optical sheet was manufactured in the same manner as in Example 1, with the exception that the wave-shaped ridge of the non-uniform pattern 20 of the structured layer had an amplitude of 3 μm and a vibration cycle of 100 μm.

### Comparative Example 1

An optical sheet was manufactured in the same manner as in Examples 1 to 3, with the exception that the ridge of the non-uniform pattern was linearly formed as in the three-dimensional structures of the uniform pattern groups.

The structure thereof is shown in FIG. 3.

### Comparative Example 2

An optical sheet was manufactured in the same manner as in Examples 1 to 3, with the exception that the structured layer having a pitch (p) of 50 μm and a height (h) of 25 μm was formed.

### Comparative Example 3

An optical sheet was manufactured in the same manner as in Examples 1 to 3, with the exception that the structured layer having a pitch (p) of 50 μm, a height (h) of 25 μM, an amplitude of 5 μm and a vibration cycle of 100 am was formed.

The optical sheets of Examples 1 to 3 and Comparative Examples 1 to 3 were evaluated as follows.

(1) Generation of Wet-Out

Two optical sheets according to the examples and comparative examples were disposed between a plurality of glass substrates, and pressure was applied to the glass substrates, and light interference (wet-out) of the films due to excessive adhesion was observed and the generation thereof was compared as follows.

Wet-out: generation ←⊚-◯-Δ-X→ non-generation

(2) Evaluation of Scratch Resistance

Scratch resistance was evaluated using the measuring device of FIG. 4.

In FIG. 4, \textcircled{1} is an up sheet (44% Haze pol.), \textcircled{2} is an evaluation optical sheet (which is the sheet of the examples and comparative examples, vertical cutting in a moving direction), \textcircled{3} is a moving support (glass substrate, moving rate 30 cm/min), \textcircled{4} is a counterpoise (10 g, 50 g, radius of a contact area 20 mm), and \textcircled{5} is a device for measuring the coefficient of friction, available from TOYOSEIKI.

The evaluation optical sheet \textcircled{2} was held on the device.

Then, the sample \textcircled{2} was positioned on the moving support \textcircled{3} so that its structured layer faced upward and then fixed using tape. Then, the up sheet \textcircled{1} was clamped to the device so that the haze surface thereof faced the structured layer. Then, the counterpoise \textcircled{4} was disposed on the up sheet \textcircled{1}, and the moving support \textcircled{3} was moved at a predetermined rate.

The evaluation results are ascertained in the following: 1) damage to the sample is confirmed after BLU (guide plate/diffusion sheet) is turned on, and 2) a scratch is defined as the maximum weight of the counterpoise that does not cause damage.

(3) Generation of Adhesive Stains

The dummy sheet was adhered onto the optical sheet of the examples and comparative examples. After 15 days, comparisons were made on the basis of the degree of generation of adhesive stains.

Adhesive stains: generation ←⊚-◯-Δ-X→ non-generation

(4) Luminance

Luminance was measured using BM-7 available from Topcon. To a BLU (26 inches) having only a reflective sheet with the other sheets being removed, a combination of a single optical diffusion film and a single optical sheet of each of the examples and comparative examples was applied, and the luminance of the optical sheets of the examples and comparative examples was measured by an increase in luminance compared to the luminance when using the optical sheet of Comparative Example 2.

TABLE 1

| | | | |
|---|---|---|---|
| Generation of | Scratch | Generation of | |
| wet-out | resistance | adhesive stains | Luminance |

| | | |
|---|---|---|
| Ex. 1 | 300 g | 100% |
| Ex. 2 | 300 g | 100% |
| Ex. 3 | 300 g | 100% |
| C. Ex. 1 | 250 g | 100% |
| C. Ex. 2 | 250 g | 100% |
| C. Ex. 3 | 300 g | 99.8% |

As is apparent from the above results, the contact area can be minimized thanks to the non-uniform pattern, thus preventing wet-out, improving scratch resistance and minimizing the drop in performance of the optical sheet attributed to the adhesive stains.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An optical sheet, comprising a structured layer having an array of a plurality of three-dimensional structures in a prism shape having a triangular cross-section, wherein the structured layer has uniform pattern groups each including 5˜20 three-dimensional structures having a same height, and a non-uniform pattern disposed between the uniform pattern groups and having a three-dimensional structure whose height is greater than the height of the three-dimensional structures of the uniform pattern groups and whose ridge is provided in a wave shape having a vertical amplitude.

2. The optical sheet of claim 1, wherein the height of the three-dimensional structure of the non-uniform pattern is at least 10% greater than the height of the three-dimensional structures of the uniform pattern groups.

3. The optical sheet of claim 2, wherein the height of the three-dimensional structure of the non-uniform pattern is 15˜25% greater than the height of the three-dimensional structures of the uniform pattern groups.

4. The optical sheet of claim 1, wherein a pitch of the three-dimensional structure of the non-uniform pattern is at least 10% greater than a pitch of the three-dimensional structures of the uniform pattern groups.

5. The optical sheet of claim 4, wherein the pitch of the three-dimensional structure of the non-uniform pattern is 15˜25% greater than the pitch of the three-dimensional structures of the uniform pattern groups.

6. The optical sheet of claim 1, wherein the structured layer is formed of any one selected from among polymer resins including UV or thermal curable resins.
